(19) United States
(12) Patent Application Publication
(10) Pub. No.: US 2015/0190805 A1
(43) Pub. Date: Jul. 9, 2015

(54) FLUID DELIVERY DEVICES, SYSTEMS, AND METHODS

(71) Applicant: Daktari Diagnostics, Inc., Cambridge, MA (US)

(72) Inventors: Robert Etheredge, Natick, MA (US); Iain Grierson McDerment, Hertfordshire (GB); Aaron Oppenheimer, Cambridge, MA (US)

(21) Appl. No.: 14/591,696

(22) Filed: Jan. 7, 2015

Related U.S. Application Data
(60) Provisional application No. 61/924,565, filed on Jan. 7, 2014.

(51) Int. Cl. B01L 3/00

(52) U.S. Cl. CPC B01L 3/502715; B01L 3/52; B01L 2200/0605

(57) ABSTRACT

This document provides devices, systems, and methods for delivering fluids. In some cases, the devices, systems, and methods include a reservoir including a sealed flexible material defining a cavity and a housing around the sealed flexible material. The cavity can contain a fluid to be delivered. The sealed flexible material includes at least one breakable seal. The housing includes a rigid side wall supporting said sealed flexible material. In some cases, methods provided herein can deliver fluid by pressing against a top surface of said sealed flexible material. In some cases, systems provided herein can include a controller adapted to receive said cartridge and press a top surface of said sealed flexible material to pressurize said fluid in said cavity to a pressure sufficient to deliver fluid past said breakable seal.

### CROSS-REFERENCE TO RELATED APPLICATIONS

This application claims benefit of priority from U.S. Provisional Application Ser. No. 61/924,565, filed on Jan. 7, 2014.

### TECHNICAL FIELD

This document relates to devices, systems, and methods involved in delivering fluids. For example, this document provides reservoirs configured to precisely meter small volumes of reagent, which can be used in microfluidic systems for diagnosing one or more disease conditions.

### BACKGROUND

In parts of the world, diseases such as HIV infection (and various stages of the disease), syphilis infection, malaria infection, and anemia are common and debilitating to humans, particularly to pregnant women. For example, nearly 3.5 million pregnant women are HIV-infected, and nearly 700,000 babies contract HIV from their mothers each year. These infant HIV infections can be prevented by identifying and treating mothers having HIV. In addition, nearly 20% of pregnant women in developing countries are infected with syphilis, leading to more than 500,000 infant stillbirths and deaths each year. Nearly 10,000 women and 200,000 infants die each year from malaria during pregnancy, and nearly 45% of pregnant women in developing countries suffer from anemia as a result of, for example, worm infections, parasites, and/or nutritional deficiencies. Anemia can adversely affect a pregnant woman's chance of surviving post-partum hemorrhage and stunt infant development. About 115,000 maternal deaths and 500,000 infant deaths have been associated with anemia in developing countries. Point-of-care medical diagnostic tools, however, can require one or more reagents, which must be stored in a stable environment until they are used, at which point they must be dispensed in precisely controlled volumes and flow rates.

### SUMMARY

This document provides devices, systems, and methods for precise flow rates of fluids and precise metering of small volumes of fluid. Devices, systems, and methods provided herein can also store fluids in a stable and sterile environment. Assays on small amounts of sample (e.g., blood) can require precise metering of small volumes of reagents. In some cases, point-of-care diagnostic products provided herein can store and precisely meter reagent, which can ensure a fresh reagent supply, safe disposal of the sample, and the cleanliness of reusable equipment.

Devices, systems, and methods can include a reservoir including a sealed flexible material defining a cavity and a housing around the sealed flexible material. The cavity can contain a fluid to be delivered. The sealed flexible material can include at least one breakable seal. The housing can include a rigid side wall supporting said sealed flexible material. In some cases, methods provided herein can deliver fluid by pressing against a top surface of the sealed flexible material. In some cases, systems provided herein can include a controller adapted to receive said cartridge and press a top surface of said sealed flexible material with a load sufficient to pressurize said fluid in said cavity to a pressure sufficient to deliver fluid past said breakable seal. Reservoirs provided herein can be used to provide steady flow rates. For example, steady flow rates can improve the accuracy of a diagnostic test. In some cases, methods and systems provided herein can use reservoirs provided herein to maintain a desired flow rate with no more than a 20% fluctuation for at least 10 seconds.

In some aspects, a system for controlled fluid delivery in a microfluidic device provided herein can include the use of a cartridge including a reservoir and a controller. The controller can be adapted to receive the cartridge. For example, the controller can be adapted to receive the cartridge and run one or more diagnostic tests (e.g., to discover a disease condition).

In some cases, a system for controlled fluid delivery provided herein includes a cartridge including at least one reservoir and a controller adapted to receive the cartridge. The reservoir can include a sealed flexible material defining a cavity and a housing around said sealed flexible material. The cavity can contain a fluid. The sealed flexible material can include at least one breakable seal. The housing can include a rigid side wall supporting the sealed flexible material. The controller can be adapted press a top surface of said sealed flexible material to pressurize said fluid in said cavity to a pressure sufficient to deliver fluid past the breakable seal.

In some cases, the system can include a rigid plunger. A controller can press on the top surface of the sealed flexible material by applying a load to the rigid plunger. As the plunger moves downward, the sealed flexible material can act as a rolling diaphragm. The load can be applied with a force sufficient to pressurize the sealed flexible material to a pressure sufficient to break the breakable seal. An inner surface of the rigid plunger can be flat. In some cases, the housing and/or the sealed flexible material of the system can be cylindrical. In some cases, the rigid housing and the rigid plunger leave a small surface area (e.g., less than 0.5 cm², less than 0.25 cm², or less than 0.1 cm²) of the sealed flexible material exposed, which can limit an amount of elastic expansion of the sealed flexible material due to the pressure from the rigid plunger.

A controller provided herein can be adapted to press a top surface of a reservoir provided herein such that the system produces a constant flow out of the sealed flexible material. In some cases, a controller provided herein can be adapted to deliver said fluid at a rate of between 7 μl/min and 300 μl/min. In some cases, a controller provided herein can include a stepper-motor capable of moving a pressing device with micron-level advancement and an encoder to provide feedback regarding the position of the pressing device.

A sealed flexible material in a reservoir provided herein can be formed between two flexible webs bonded together with a peripheral seal and a breakable seal. In some cases, a breakable seal is adapted to open when load on an upper surface of the reservoir exceeds between 2N and 35N. In some cases, the sealed flexible material comprises a polymer. The polymer can be selected from the group consisting of polyolefins, polyesters, polyamides, polyimides, cyclic olefin polymers and copolymers, other liquid containment polymers, and combinations thereof.

A cartridge provided herein can include one or more microfluidic channels arranged to receive fluid from the reservoir. A breakable seal of the reservoir can be positioned to deliver said fluid to a microfluidic channel when fluid is delivered past the breakable seal. In some cases, a cartridge provided herein can include at least one impedance-measurement circuit that can be used by a controller to determine a location of fluid in the cartridge. In some cases, a cartridge provided herein can include at least two reservoirs provided herein. In some cases, a cartridge provided herein can include at least three reservoirs provided herein, each reservoir including a different fluid (e.g., a different reagent). In some cases, the sealed flexible material can be bonded to a flat base around the rigid sidewall.

The housing of a reservoir provided herein can include a lip on the sidewall. The lip can extend over a portion of a top surface of the sealed flexible material. In some cases, the lip covers between 1% and 20% of a top surface of the sealed flexible material and a rigid plunger covers at least 80% of the top surface. The lip and the plunger can be arranged to promote a desired folding pattern in the sealed flexible material as fluid is pushed out of the sealed flexible material. In some cases, an inner surface of the side wall can include ribs arranged to create a desired folding pattern the sealed flexible material (e.g., in the first web vacuum formed against the housing). In some cases, a plunger can be keyed into slots in the housing side wall to create a rotation of the plunger and the top surface of the sealed flexible material as the plunger is advanced to create a desired folding pattern. In some cases, the plunger can be fused to the first web. In some cases, the plunger can be separate from the first web. In some cases, both the first web and the plunger can include the same polymer or same class of polymer (e.g., both could be COO polymers). In some cases, a hole can be made through the plunger and the first web. In some cases, a port fitted through the plunger and the first web. For example, a hole or port in the plunger and the first web can be used for pumping contents into or out of the top side of the reservoir. In some cases, a hole or port in the plunger and the first web can allow a flow-thru of reagents, wash solution, or other fluid through the reservoir. In some cases, the reservoir can include binding agents adapted to bond to target analyses, and the reservoir can be flushed with a washing fluid to remove non-target constituents in the sample.

In some cases, methods, devices, and systems provided herein can include a flexible or compliant matrix within a reservoir provided herein.

The details of one or more embodiments are set forth in the accompanying drawings and the description below. Other features and advantages will be apparent from the description, the drawings, and the claims.

### DESCRIPTION OF DRAWINGS

FIG. 1 depicts an example of a fluid delivery system provided herein.

FIG. 2 is a diagram of an exemplary cartridge including a series of reservoirs provided herein.

FIG. 3 is a bottom view of flexible webs bonded to a housing showing the positions of the seals.

FIG. 4A depicts a reservoir having the housing removed.

FIG. 4B depicts the reservoir of FIG. 4A after fluid is dispensed having the housing removed.

FIG. 5 depicts a force diagram showing the force needed to deliver fluid using a system provided herein.

FIG. 6 depicts exemplary flow rates produced by a fluid delivery system provided herein.

FIG. 7 depicts an exemplary production assembly line.

FIG. 8 depicts a controller adapted to receive a cartridge including a reservoir provided herein.

FIG. 9 depicts an example of a fluid delivery system provided herein having a flexible or compliant matrix within the reservoir.

FIG. 10 depicts another example of a fluid delivery system provided herein having a flexible or compliant matrix within the reservoir.

Like reference symbols in the various drawings indicate like elements.

### DETAILED DESCRIPTION

This document provides methods and devices related to metering precise amounts of fluid at precise flow rates. In some cases, the devices, systems, and methods provided herein relate to diagnosing one or more disease conditions (e.g., HIV infections, syphilis infections, malaria infections, anemia, gestational diabetes, and/or pre-eclampsia). For example, a biological sample (e.g., blood) can be collected from a mammal (e.g., pregnant woman) and analyzed using a kit including a cartridge including one or more reservoirs provided herein, each reservoir including a reagent, such that the reagent can be mixed with the biological sample using a controller that receives the cartridge to determine whether or not the mammal has any of a group of different disease conditions. In the case of a device that diagnoses multiple disease conditions, the analysis for each disease condition can be performed in parallel, for example using different reagents from different reservoirs, such that the results for each condition are provided at essentially the same time. In some cases, the devices, systems, and methods provided herein can be used outside a clinical laboratory setting. For example, the devices, systems, and methods provided herein can be used in rural settings outside of a hospital or clinic. Any appropriate mammal can be tested using the methods and materials provided herein. For example, dogs, cats, horses, cows, pigs, monkeys, and humans can be tested using a diagnostic device or kit provided herein.

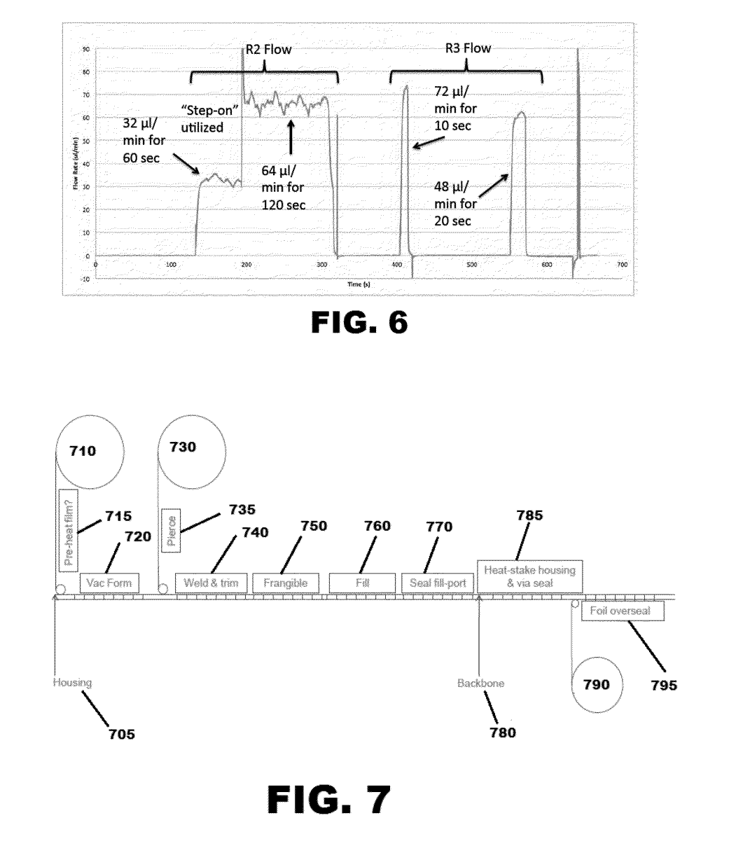

The devices, systems, and methods provided herein can provide precise metering of small volumes and flow rates of reagents for tests that determine whether or not the mammal has one or more disease conditions. In some cases, devices, systems, and methods provided herein can repeatedly deliver a predetermined and constant flow and/or volume of fluid with a deviation of not more than 20% (e.g., not more than 10% deviation, not more than 5% deviation, not more than 3% deviation, not more than 2% deviation, not more than 1% deviation, or not more than 0.5% deviation). In some cases, a flow rate can have a desired flow rate within a predetermined deviation (e.g., 20%, 15%, 10%, 5%, 3%, 1%) over a desired time period (e.g., at least 2 seconds, at least 5 seconds, at least 10 seconds, or at least 20 seconds). The deviation of a device or method provided herein can be assessed by metering ten consecutive volumes of fluid including a reporter molecule (e.g., a fluorescent additive or radiolabel such as tritium), using a signal from the reporter molecule to determine an average volume of each metered fluid (e.g., using a plate-reader), and determining the maximum deviation from that average volume and dividing that maximum deviation by the average volume to determine the deviation. In some cases, an average volume of metered fluid can be determined using Karl Fisher analysis. In some cases, devices, systems, and methods provided herein can be arranged to meter a predetermined volume of fluid of 500 μL or less (e.g., 250 μL or less, 100 μL or less, 75 μL or less, 50 μL or less, 25 μL or less, 10 μL or less, or 5 μL or less). In some cases, devices, systems, and methods provided herein can be arranged to meter a predetermined flow of fluid of between 1 μL/min and 500 μL/min (e.g., between 2 μL/min and 250 μL/min, between 5 μL/min and 100 μL/min, between 7 μL/min and 75 μL/min, between 10 μL/min and 50 μL/min, or between 20 μL/min and 40 μL/min). Flow rates can be measured using a precision flow meter. For example, precision flow meters sold by Senserion can be used to measure low flow rates (e.g., 10 ul/min) and high flow rates (e.g., 1000 ul/min). A flow sensor can be attached to the exit via of the reservoir or at various locations along the fluidic path to measure the flow. For example, for the data shown in FIG. 6, a flow sensor was attached to the exit via of the cuvette of a cartridge.

Reservoirs provided herein can also be used in non-diagnostic devices. In some cases, reservoirs provided herein can be used for the delivery of fluids such as medicines, colorants, flavorants, and/or combinations thereof. For example, a reservoir provided herein can be filled with a medication, and a controller could be used to infuse a precise amount of that medication to a mammal based on a predetermined schedule. In some cases, reservoirs provided herein can include flavorants and/or colorants and be used to with a controller to create custom drinks or foods. Other applications for the precise delivery of one or more fluids are also contemplated. In some cases, two or more reservoirs can be connected to one another through a breakable seal for mixing of two liquids, a liquid and a solid (such as a lyophilized power), or other components. A second breakable seal may then be breached to provide flow of the combined materials.

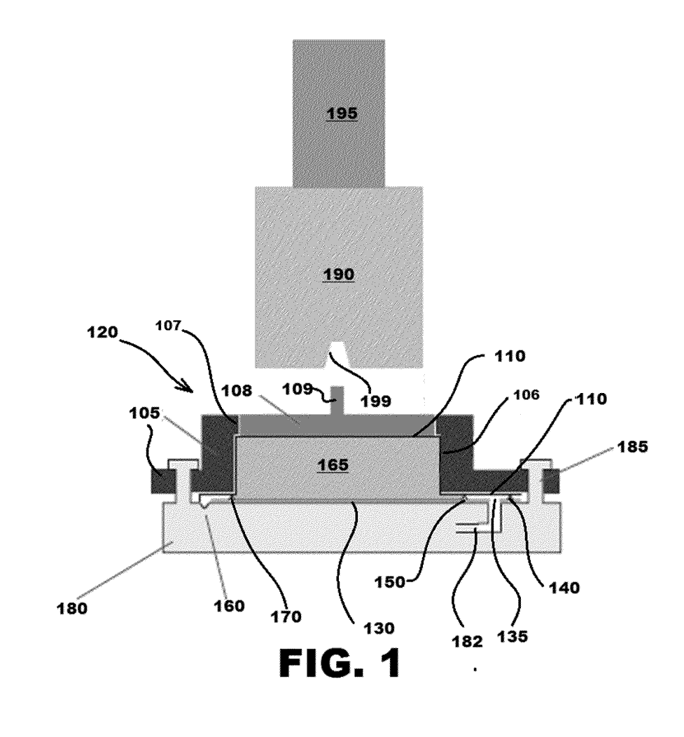

FIG. 1 depicts an exemplary system including a reservoir 120 and a pressing device 190. As shown, reservoir 120 is within sealed flexible material 110 and 130, which is surrounded and supported by a rigid housing 105, including a rigid side wall 106, a rigid plunger 108, and a backbone 180. Reservoir 120 can include fluid 165 (e.g., reagent) enclosed in a cavity formed between a first web 110 and a second web 130 of flexible material. First web 110 is positioned against rigid side wall 106 and rigid plunger 108. For example, first web 110 can be vacuum formed against rigid housing 105, both with or without rigid plunger 108 in place. Second web 130 is bonded to first web 110 by peripheral seal 140, fill seal 170, and breakable seal 150. As will be discussed in more detail below, peripheral seal 140 can be made prior to filling reservoir 120 with fluid 165. A fill gap 160 in the peripheral seal can provide a path for filling reservoir 120 with fluid 165. After filling reservoir 120 with fluid 165, a fill seal 170 can be made to seal the fill gap. Peripheral seal 140 and fill seal 170 can form a durable seal between first web 110 and second web 130. For example, the bond at peripheral seal 140 and fill seal 170 can be stronger than the material strength of first web 110 and second web 130. In some cases, peripheral seal 140 and fill seal 170 are melt bonded. In some cases, first web 110 is in intimal contact with housing 105 to prevent a loose fit and energy loss. Having first web 110 in intimal contact with housing 105 can allow for pure hydraulic action. Moreover, eliminating or minimizing energy loss or storage in elastic or viscoelastic structure can improve the hydraulic action.

Breakable seal 150 can be positioned to isolate an opening 135 in second web 130. Breakable seal 150 is adapted to break when pressure within the sealed flexible material 110 and 130 exceeds a threshold, but prior to the breakage of other parts of the reservoir 120 or other seals of the reservoir 120. In some cases, the threshold is between 5N and 50N, between 10N and 30N, or between 15N and 20N. Peripheral seal 140 and fill seal 170 must be more durable seals than breakable seal 150. As will be discussed in additional detail below, the processing conditions used when making each seal determines the strength of each seal.

Housing 105 can include a lip 107 on the side wall 106 that extends partially over a top elevated surface of first web 110. Rigid plunger 108 can sit within lip 107 on the top surface of first web 110. Rigid plunger 108 is free to move up and down relative to side wall 106. A pressing device 190 can be used to apply force (e.g., about 10N to 20N) to rigid plunger 108 to increase pressure within the reservoir 120 to a sufficient pressure to break breakable seal 150 such that fluid flows past breakable seal 150, through opening 135 in second web 130, and into one or more channels 182 in backbone 180. Lip 107 can provide a clearance space around the periphery of reservoir 120 for first web 110 to fold and/or roll upon itself as rigid plunger 108 is moved downward as fluid is pushed out of reservoir 120. In some cases, lip 107 has an inner surface area of less than 20% of the surface area of a top projecting surface of first web 110, of less than 15% of the surface area of a top projecting surface of first web 110, 10% of the surface area of a top projecting surface of first web 110, or 5% of the surface area of a top projecting surface of first web 110. Having a lip can promote a folding action of the first web 110 as fluid exits the reservoir. If small volumes of air or bubbles are present within a reservoir provided herein, the air or bubbles can become trapped within folds of the side walls as the reservoir is compressed, and thus prevented being pushed past the breakable seal. For example, in some diagnostic devices, air bubbles can disrupt a test if air bubbles enter a microfluidic channel, thus reservoirs provided herein can improve the reliability of a diagnostic device. In some cases, housing 105 can include internal ribs or other features designed to cause certain folding patterns in the first web 110 due to the vacuum forming of the first web against housing 105. In some cases, plunger 108 can be keyed into slots in side wall 106 to cause plunger 108 to rotate as the pressing device advances to promote a desired fold pattern.

A backbone 180 can support reservoir 120. Backbone 180 can be bonded to housing 105 by any suitable method. For example, as shown in FIG. 1, backbone 180 can be attached to housing 105 by heat stakes 185. Backbone 180 can include a microfluidic channel 182 and/or other channels adapted to receive fluid 165 from reservoir 120. For example, backbone 180 can include chambers adapted to mix a biological sample (e.g., blood) with one or more reagents for the detection of one or more disease characteristics. In some cases, backbone 180 can include a cutout under breakable seal 150 to support seal breakage.

Pressing device 190 can have any suitable shape or size. Pressing device 190, in some cases, can include an alignment feature 199, which can mate with an alignment feature 109 of rigid plunger 108. Movement of pressing device 190 can be controlled with a motor 195. In some cases, rigid plunger 108 can be eliminated from the reservoir and the pressing device 190 can have a flat pressing surface that presses directly against the top projecting surface of first web 110.

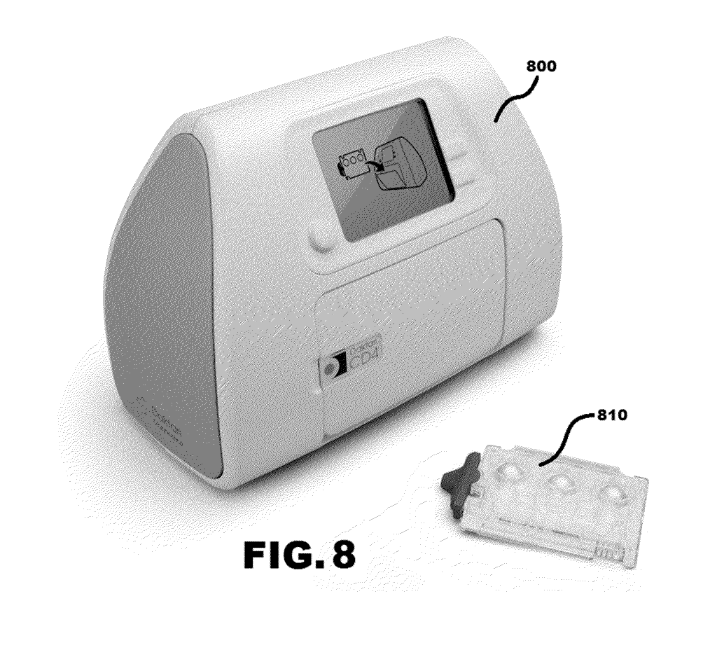

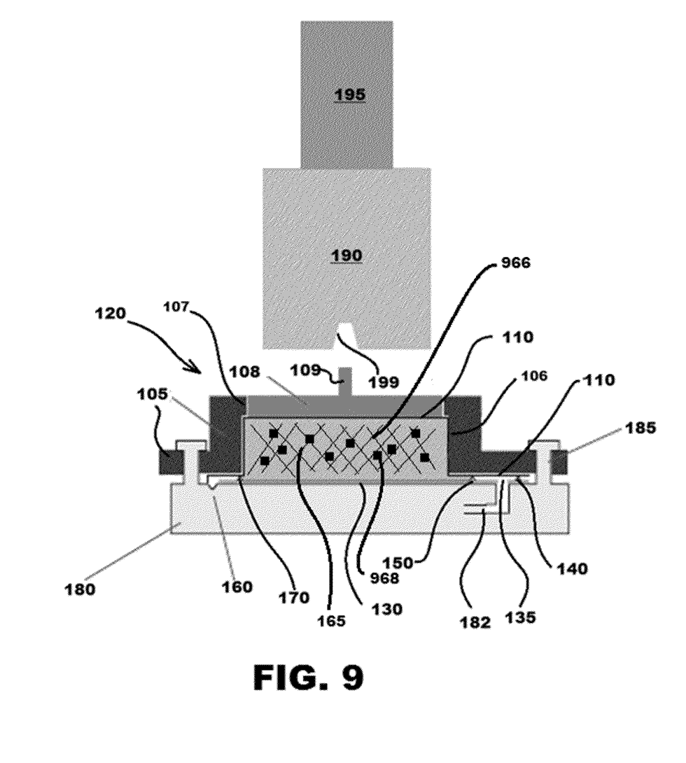

Pressing device 190 can be pressed against reservoir 120 such that it produces a controlled flow of fluid past breakable seal 150. In some cases, motor 195 can include a stepper-motor capable of moving pressing device 190 with micron-level advancement. In some cases, motor 195 can include an encoder to provide feedback regarding the position of pressing device 190. In some cases, a controller is used to move pressing device 190. For example, FIG. 8 depicts an exemplary controller 800 adapted to receive a cartridge 810 including one or more reservoirs provided herein. In some cases, the controller is adapted to deliver said fluid at a rate of between 1 μl/min and 500 μl/min, between 2 μl/min and 250 μl/min, between 5 μl/min and 100 μl/min, between 7 μl/min and 75 μl/min, between 10 μl/min and 50 μl/min, or between 20 μl/min and 40 μl/min.

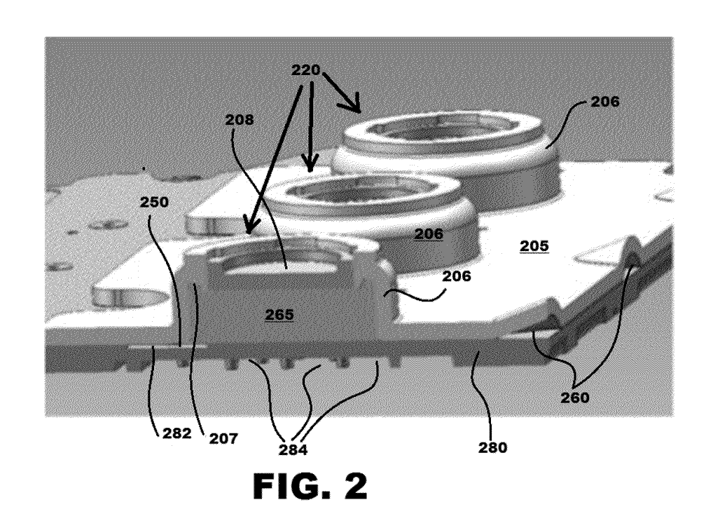

FIG. 2 depicts an example cartridge including a plurality of reservoirs 220 provided herein. Although difficult to see, reservoirs 220 include a sealed flexible material within a cavity formed between backbone 280, side walls 206, lips 207, and rigid plungers 208. As shown, housing 205 includes fill ports 260, which can facilitate the filling of a cavity defined by sealed flexible material in the reservoirs 220. Sealed flexible material can include a first and second webs such as those described above in regard to FIG. 1. Lip 107 of rigid housing 105 can be shaped to promote the folding and/or rolling of flexible material along a periphery of the cavity 212.

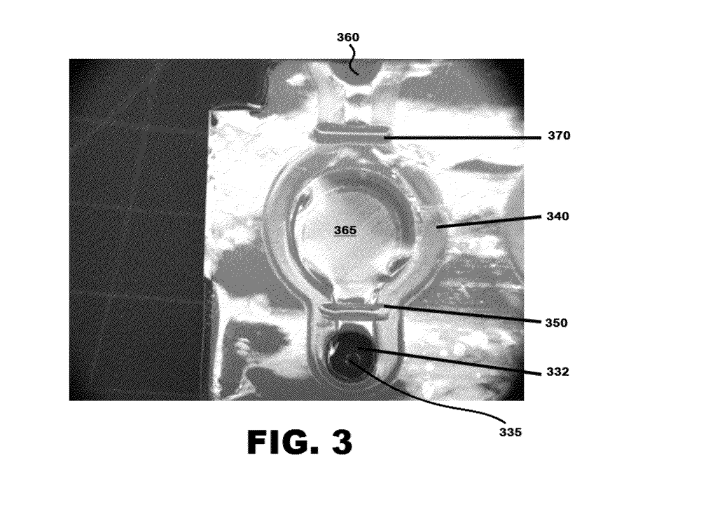

FIG. 3 shows a bottom view of flexible webs bonded to a housing highlighting the positions of the seals. As shown, a peripheral seal 340 extends around the cylindrical cavity 365, defines an outflow port 332, and leaves a fill gap to allow for fluid to be delivered through fill port 360. The outflow port 332 includes an opening 335 in a second web. A breakable seal 350 isolates the outflow port and opening 335 from the remainder of the cavity. After a fluid is provided to the cavity though fill port 360, a fill seal 370 is made to enclose the reservoir.

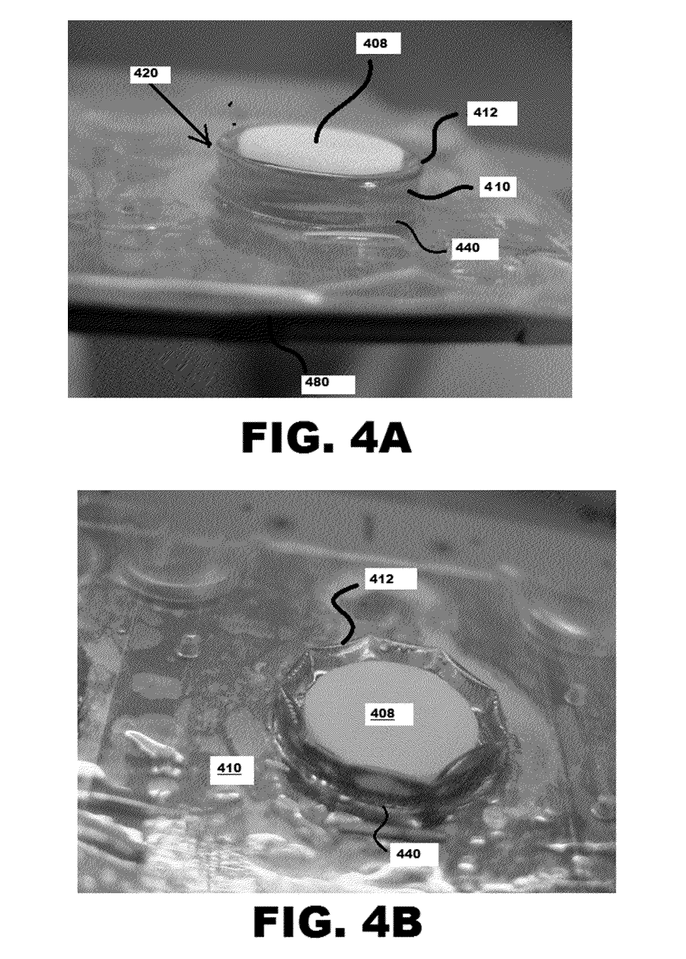

FIGS. 4A and 4B depict a reservoir 420 with the housing removed. As shown, first web 410 and second web (not numbered) 430 are bonded together along peripheral seal 440 to form a cavity filled with fluid. Rigid plunger 408 is positioned on a top projecting surface of web 410. As the rigid plunger 408 is pressed against web 410 to push fluid out of the reservoir 420, web 410 can fold and/or roll upon itself along a peripheral ridge 412 of the cavity. As shown in FIG. 4B, air bubbles can congregate along peripheral ridge 412 and thus get trapped in the folds of the side walls of the reservoir as the reservoir is compressed, which can inhibit the passage of air bubbles into channels in backbone 480.

Reservoirs provided herein can be made of any suitable material. In some cases, reservoirs provided herein can include a polymer. Sealed flexible material can be a polymer. For example, sealed flexible material can be selected from polyolefins (e.g., polyethylenes), polyurethanes, thermoplastic elastomers, polyesters, polyamides, polyimides, cyclic olefin copolymers, other liquid containment polymers, and combinations thereof. A thickness of the sealed flexible material can insure that it is compliant. In some cases, the thickness of the sealed flexible material (e.g., webs 110 and 130) is between 25 microns and 500 microns, between 100 microns and 250 microns, or between 125 microns and 175 microns. The rigid housing 150 or 250 or 350 and rigid plunger 140 or 540 can be made out of any suitable rigid material, such as a plastic, metal, and/or ceramic material. In some cases, a thickness of the housing and/or plunger can add rigidity. In some cases, the housing and the sealed flexible material can be formed of the same polymer, but have different thicknesses. For example, webs of cyclic olefin copolymer having thicknesses of about 150 microns can form the sealed flexible material while a housing can be formed out of cyclic olefin copolymer (“COO”) and have a thickness of between 1 millimeter and 5 millimeters. In some cases, flexible webs can be melt bonded to portions of a housing. In some cases, the use of COO (and similar polymers that also have a tendency to stick together even in the presence of water) can improve the reliability in a microfluidic diagnostic device. For example, when a breakable seal is initially ruptured, the pressure used to rupture the breakable seal can cause a large initial flow into a microfluidic system, which can sometimes push air into the microfluidic system. By using COO or similar polymers, a natural stiction between the polymer films downstream of the breakable seal, even after the seal is broken, can dampen the initial flow rate. The use of COO or similar polymers can also reduce unintended flow from the reservoir by forming a weak stiction seal after pressure on the reservoir is removed to halt the flow of fluid past the breakable seal. The weak stiction seal, however, can be easily opened by reapplying pressure. Typical forces to convey liquid from the reservoir are in the range of 0.4-1.0 Newton force

In some cases, the reservoir can include a UV, e-beam, or gamma irradiation transparent polymer. For example, cyclic olefin copolymer is sufficiently transparent to 280 nm wavelength UV, e-beam, and gamma irradiation, thus a reservoir made out of cyclic olefin copolymer can allow for an easy sterilization of the reagent after the reagent is sealed in the reservoir.

Reservoirs provided herein can provide a better control of fluid flows leaving the reservoirs due to the sealed flexible material and the rigid housing. Side walls of a rigid housing provide support for the sealed flexible material as the sealed flexible material is pressed by a plunger, thus a minimal amount of the pressing energy is stored in the form of elastic deformation of the reservoir. Without the housing, a sealed flexible material pressed by a pressing device could elastically deform (e.g., balloon), and could then recover after pressing ceases, thus continuing a fluid flow even after a pressing force is withdrawn. The rigid housing, however, can prevent this elastic deformation. Additionally, the cylindrical shape of the cavity and the use of a flat plunger can result in a high utilization (e.g., greater than 60%, greater than 70%, greater than 80%, or greater than 90%) of fluid within the reservoir. This is critical when using small amounts of high value actives that must be delivered to the assay without waste.

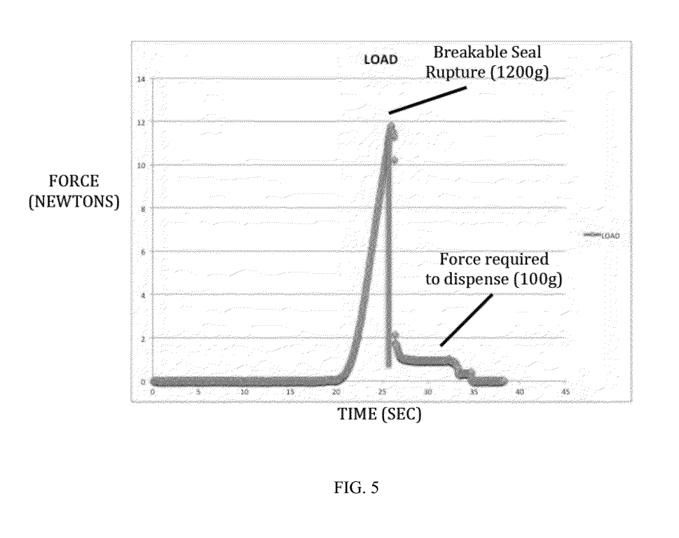

FIG. 5 depicts the pressing forces used to deliver fluid from an exemplary reservoir provided herein. As shown, an initial force of between about 10N and 14N and rigid plunger travel of only 250 microns is used to break the breakable seal. \After the breakable seal is broken, a force between 0.4N and 1N (100 grams force) is used to provide a steady flow of fluid from a reservoir provided herein. FIG. 6 depicts an exemplary delivery profile of two different reagents using reservoirs provided herein. As shown, consistent flow rates can be obtained using reservoirs provided herein. In some cases, between pumping phases, a natural stiction between hydrophobic polymer webs can stop the flow of fluid from the reservoir. As noted above, however, a natural stiction forms a weak seal, which can be easily broken by reapplying pressure.

FIG. 7 depicts an exemplary assembly line for producing reservoirs provided herein. As shown, a housing 705 is provided and combined with a first flexible film 710 from a reel. In some cases, one or more plungers can also be provided included with the housing 705 for the combination with the first flexible film 710. Housing 705 and plungers can be formed using any suitable technique, including injection molding, thermo molding, or compression molding. In some cases, housing 705 and plunger(s) can be co-molded. In some cases, housing 705 and plunger(s) are separately formed and combined thereafter. The flexible film 710 can be preheated prior to vacuum molding 720 first flexible film 710 against the housing 705. A second flexible film 730 can also be provided on a reel. Second flexible film 730 can be pierced 735 prior to welding the second flexible film to first flexible film 710 and trimming the flexible films in station 740. A breakable or frangible seal is at station 750 to isolate the pierced hole formed at station 735 from a remainder a cavity formed between first and second flexible films 710 and 730. The cavity is then filled with a fluid through a fill gap at station 760 and the cavity is fully sealed by sealing the fill gap at station 770. A backbone 780 is then aligned and bonded to the sealed flexible films and the housing at station 785. A foil 790 can be provided on a reel and sealed against a top side of housing 705 at station 795. In some cases, foil 790 can be applied to a top side of housing 705 after first flexible film 710 is vacuum formed against housing 705 at station 720. Foil seal can be removed by a user prior to use, but provide protection for the reservoir while the reservoir is being packaged, shipped, and/or stored.

FIG. 8 depicts an exemplary controller 800 adapted to receive a cartridge 810 including one or more reservoirs provided herein.

FIG. 9 depicts an embodiment of a fluid delivery system provided herein having a flexible or compliant matrix 966 within reservoir 120. As shown, reservoir 120 can have the same structure and same components as shown in FIG. 1, but additionally include fibrous matrix 966 in a cavity between first web 110 and second web 130. Fibrous matrix 966 can be compressed into a smaller volume when rigid plunger 108 is pressed down. In some cases, fibrous matrix 966 can retain solid or semisolid particles 968. In some cases, particles 968 can include reagents and/or anticoagulants. In some cases, particles 968 can be target capture agent particles.

In some cases, reservoir 120 can be present in a microfluidic device in a pre-compressed state and can include fibrous matrix 966. In some cases, a pre-compressed reservoir can be used as a mixing chamber in a microfluidic device. Reservoir 120 can be expanded by pumping into the reservoir and again compressed to press fluid out of the cavity between first web 110 and second web 130. In some cases, particles 968 can be target capture agent particles. For example, in some cases, a biological sample fluid can enter reservoir 120 by pumping the biological sample into the reservoir to expand the reservoir such that targets within the biological sample bind to the target capture agent particles. After the sample contacts the target capture agent particles, the biological sample can be removed by pressing rigid plunger 108 down. In some cases, reservoir 120 can include an inlet and an outlet at opposite sides of the reservoir. In some cases, rigid plunger 108 can be oscillated to encourage mixing. In some cases, biological sample can be additionally washed out of reservoir 120 by pumping a washing solution into reservoir and pressing rigid plunger 108 down to remove the washing solution. In some cases, multiple wash cycles can ensure that unwanted biological agents are removed from reservoir 120. A lysis buffer can then be pumped into reservoir 120 to lyse the target, and the resulting lysate can be pumped out of reservoir 120 by pressing rigid plunger 108 down. The lysate can be collected and analyzed. In some cases, fibrous matrix can instead include a foam or microporous network. In some cases, analysis of the lysate can indicate an amount of targets found (e.g., a viral load). In some case, a doctor or health care professional may utilize data from devices, systems, and methods provided herein to assist with a diagnosis. In some cases, one or more portions of reservoir 120 can be transparent at a predetermined wavelength. For example, reservoir 120 can include COC, which is transparent from 280 nm past 1 micron. In some cases, reservoir 120 can be used as a reaction vessel and the contents analyzed spectrometrically. For example, rigid plunger 108 can form a lens over a small spectrometer-like diode light source housed in an actuator and the absorptivity detected using an analyzer.

Fibrous matrix 966 provided herein can be any suitable entanglement of fibers. A fibrous matrix can allow a sample to be wicked through reservoir 120 to intermix and/or contact anticoagulant, reagent, target capture agents, or a combination thereof. In some cases, methods, devices, and systems provided herein incorporate a non-woven web as the fibrous matrix. Non-woven webs in methods, systems, and devices provided herein can be prepared using any suitable material and any suitable process. Anticoagulant and/or target capture agents may be mixed with structural fibers forming the fibrous matrix during any point in the various processes of processing, producing, and/or further manipulating the structural fibers to produce the anticoagulant/target capture agent entangled fibrous matrix. Suitable methods include the dry laid system, spun bond systems, spun laced systems, melt blown systems, and e-spun systems.

Fibers in fibrous matrix can include the full array of extrudable polymers, such as polypropylene, polyethylene, PVC, viscose, polyester, and PLA. In some cases, the structural fibers have low extractables and/or are biologically inert.

In some cases, anticoagulant and/or target capture agents can be blown by a blower into a stream of melt-blown or spun bond structural fibers exiting a die in a horizontal process. The stream of anticoagulant and/or target capture agents entangled with the structural fiber can be collected and calendared between a pair of vacuum drums. Calendaring can be used in combination with heat (either added or latent) to bond the structural fibers. In some cases, additional methods of bonding or entangling the structural fibers can be used in fibrous matrix.

In some cases, the anticoagulant and/or target capture agents/fibrous matrix can further processed to further secure the anticoagulant and/or target capture agents within the fibrous matrix. For example, the fibrous matrix composite may be needled, needle punched, needle felted, air jet entangled, spun laced, or hydroentangled.

Target capture agents can be incorporated into a fibrous matrix to capture a desired target to separate the target from remaining biological constituents. Accordingly, the selection of the target capture agent is highly dependent on the target. For example, in some cases, the target is a virus and the target capture agent is a virion capture agent. Suitable target capture agents include anit apoE ab1, anti apoE ab2, anti apoE ab3, anti apoE ab3, anti E2 ab2, anti E2 ab4, heparin, E2 aptamer, DC-SIGN-Fc chimea, protein G mag beads, streptavidin mag beads, Ni-NTA mag beads, apoH mag beads, MBP-6×His-no CaCl2, and combinations thereof.

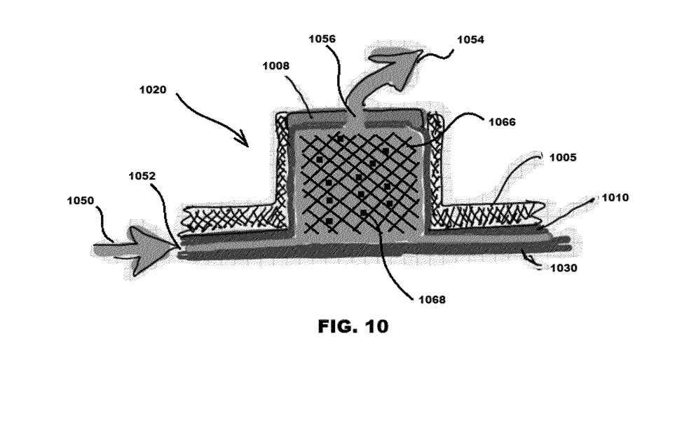

FIG. 10 depicts an alternative arrangement of a reservoir 1020 provided herein having an inlet 1052 and an outlet 1054 adapted so that fluids 1050 & 1054 can pass through a cavity formed between a first web 1010 and a second web 1030. As shown, the inlet port 1052 can be formed between first web 1010 and second web 1030. A fluid 1052 (e.g., a biological sample) can be pumped into reservoir 1020 such that it fills intermixes with fibrous or compliant matrix 1066 and/or particles 1068. Particles 1068 and/or fibrous or compliant matrix 1066 can have the same structures and/or materials as discussed above in regards to particles 968 and fibrous or compliant matrix 966 discussed above. In some cases, particles 1068 can include target capture agents. Particles 1068 can be retained in the fibrous or compliant matrix 1066 such that the pumping of fluid into or out of reservoir 1020 does not cause particles 1068 to be pumped out of reservoir 1020. After a sufficient time period, which may be between fractions of a second or multiple hours, the sample can be pumped out of outlet 1056 by pressing plunger 1008 down. Plunger 1008 and housing 1005 can be rigid structures that cooperate with first web 1010 and second web 1030 in the same manner as discussed above in regards to plunger 108, housing 105, first web 110, and second web 130. Similarly, subsequent washing fluid(s) and/or subsequent lysing agents can be pumped through reservoir 1020 to form a lysate that can then be analyzed as discussed above. In some cases, the lysate can be pumped for analysis. In some cases, the lysate can be analyzed within reservoir 1020.

A number of embodiments of the invention have been described. Nevertheless, it will be understood that various modifications may be made without departing from the spirit and scope of the invention. Accordingly, other embodiments are within the scope of the following claims.

What is claimed is:

1. A system for controlled fluid delivery in a microfluidic device comprising:
a) a cartridge comprising at least one reservoir, said reservoir comprising a sealed flexible material defining a cavity and a housing around said sealed flexible material, said cavity containing a fluid, said sealed flexible material including at least one breakable seal, said housing comprising a rigid side wall supporting said sealed flexible material; and
b) a controller adapted to receive said cartridge and press a top surface of said sealed flexible material to pressurize said fluid in said cavity to a pressure sufficient to deliver fluid past said breakable seal.

2. The system of claim 1, wherein said housing is cylindrical.

3. The system of claim 1, further comprising a rigid plunger, wherein said controller presses said top surface by applying force to said rigid plunger.

4. The system of claim 3, wherein said rigid plunger has a flat inner surface.

5. The system of claim 1, wherein said sealed flexible material is cylindrical.

6. The system of claim 1, wherein the controller is adapted to press said top surface such that said system produces a constant flow out of said sealed flexible material.

7. The system of claim 6, wherein the controller is adapted to deliver said fluid at a rate of between 7 μl/min and 75 μl/min.

8. The system of claim 1, wherein said controller comprises a stepper-motor capable of moving a pressing device with micron-level advancement against said top surface and an encoder to provide feedback regarding the position of said pressing device.

9. The system of claim 1, wherein said sealed flexible material is formed between two flexible webs bonded together with a peripheral seal and said breakable seal.

10. The system of claim 9, wherein breakable seal is adapted to open when cavity load of between 2N and 50N is applied to said sealed flexible material.

11. The system of claim 1, wherein said sealed flexible material comprises a polymer.

12. The system of claim 11, wherein said polymer is selected from the group consisting of polyolefins, polyesters, polyamides, polyimides, cyclic olefin polymers and copolymers, polyurethanes, thermoplastic elastomers, and combinations thereof.

13. The system of claim 1, wherein said cartridge comprises at least one impedance-measurement circuit, said controller being adapted to use said at least one impedance-measurement circuit to determine a location of said fluid in said cartridge.

14. The system of claim 1, wherein said cartridge further comprises at least one microfluidic channel, wherein said breakable seal is positioned to deliver said fluid to said microfluidic channel when said fluid is delivered past said breakable seal.

15. The system of claim 1, wherein said cartridge further comprises at least two of said reservoirs.

16. The system of claim 1, wherein said sealed flexible material is bonded to a flat base of said rigid side wall.

17. The system of claim 1, wherein said housing further comprises a lip on said sidewall, said lip extending over a portion of said top surface.

18. The system of claim 17, wherein said housing further comprises a rigid plunger within said lip, said rigid plunger covering at least 80% of said top surface.

19. A cartridge comprising at least one reservoir, said reservoir comprising a sealed flexible material defining a cavity and a housing around said sealed flexible material, said cavity containing a fluid, said sealed flexible material including at least one breakable seal, said housing comprising a rigid side wall supporting said sealed flexible material.

20. The cartridge of claim 19, wherein said housing is cylindrical.

21. The cartridge of claim 19, further comprising a rigid plunger adapted to move relative to said rigid side wall to press said sealed flexible material.

22. The cartridge of claim 21, wherein said rigid plunger has a flat inner surface.

23. The cartridge of claim 19, wherein said sealed flexible material is cylindrical.

24. The cartridge of claim 19, wherein said sealed flexible material is formed between two flexible webs bonded together with a peripheral seal and said breakable seal.

25. The cartridge of claim 24, wherein breakable seal is adapted to open a load of between 2N and 50N is applied to said sealed flexible material.

26. The cartridge of claim 19, wherein said sealed flexible material comprises a polymer.

27. The cartridge of claim 26, wherein said polymer is selected from the group consisting of polyethylenes, polyethylene terephthalates, polyamides, cyclic olefin copolymers, and combinations thereof.

28. The cartridge of claim 19, wherein said cartridge comprises at least one impedance-measurement circuit.

29. The cartridge of claim 19, further comprises at least one microfluidic channel, wherein said breakable seal is positioned to deliver said fluid to said microfluidic channel when said fluid is delivered past said breakable seal.

30. The cartridge of claim 19, further comprising at least a second reservoir.

31. The cartridge of claim 19, wherein said sealed flexible material is bonded to a flat base of said rigid side wall.

32. The cartridge of claim 19, wherein said housing further comprises a lip on said sidewall, said lip extending over a portion of said top surface.

33. The cartridge of claim 32, wherein said housing further comprises a rigid plunger within said lip, said rigid plunger covering at least 80% of said top surface.

34. A method for delivering a fluid, comprising:
a) aligning a reservoir and a pressing device such that a pressing surface of said pressing device is positioned opposite a top surface of said reservoir, said reservoir comprising a sealed flexible material defining a cavity and a housing around said sealed flexible material, said cavity containing a fluid, said sealed flexible material including a breakable seal, said housing comprising a rigid side wall supporting said sealed flexible material;
b) pressing said pressing device against said top surface to apply pressure evenly against at least 80% of a top surface of said sealed flexible material to break said breakable seal and deliver said fluid past said breakable seal.

35. The method of claim 34, wherein said reservoir is part of a microfluidic cartridge comprising at least one microfluidic channel, wherein pressing the pressing device against said upper surface delivers fluid to said microfluidic channel.

36. The method of claim 34, further comprising a rigid plunger positioned against at least 80% of said top surface of said sealed flexible material, wherein said pressing device presses against said rigid plunger to apply pressure evenly against at least 80% of said top surface of said sealed flexible material.

37. The method of claim 34, wherein said top surface is flat, wherein a surface pressed against said top surface is flat.

38. The method of claim 34, wherein aligning said reservoir and said pressing device includes aligning a central axis of said pressing device with a central axis of said reservoir.

39. The method of claim 34, wherein said pressing device is moved at a rate such that it produces a constant flow of said fluid past said breakable seal, wherein said constant flow is at a rate of between 7 μl/min and 75 μl/min.

40. The method of claim 34, wherein said pressing device is pressed using a stepper-motor capable of micron-level advancement.

41. A method of making a fluid-delivery reservoir comprising:
a) vacuum forming a first flexible web against a rigid housing, said rigid housing comprising a side wall;
b) applying a second flexible web against said vacuum formed first flexible web;
c) sealing said first flexible web to said second flexible web to form at least one cavity there between;
d) filling said at least one cavity with a fluid; and
e) bonding said housing and said first and second flexible webs to a rigid substrate.
